(19) United States
(12) Patent Application Publication
(10) Pub. No.: US 2016/0219155 A1
(43) Pub. Date: Jul. 28, 2016

(54) METHOD AND APPARATUS FOR HANDLING A CALL CONFLICT IN A COMMUNICATIONS NETWORK

(71) Applicant: MEDIATEK INC., Hsin-Chu (TW)

(72) Inventor: Te-Huang LIU, Zhubei City, Hsinchu County (TW)

(73) Assignee: MEDIATEK INC., Hsin-Chi (TW)

(21) Appl. No.: 14/914,154

(22) PCT Filed: May 5, 2015
(86) PCT No.: PCT/CN2015/078283

§ 371 Date: Feb. 24, 2016

Related U.S. Application Data
(60) Provisional application No. 61/988,396, filed on May 5, 2014.

(51) Int. Cl. H04M 7/00; H04L 29/06; H04W 4/16

(52) U.S. Cl. CPC H04M 7/0033; H04W 4/16; H04L 65/1006; H04L 65/1069

(57) ABSTRACT

A method for handling a call conflict in a communications network is disclosed. The method is used in a user equipment (UE) in a communications network. The method includes: receiving, by a mobile terminated (MT) call handling module, an MT call request for establishing an MT call from a network on a first access domain; detecting, by a call conflict handling module, whether a mobile originated (MO) call is being established at the same time by an MO call handling module on a second access domain; and transmitting, by a call conflict handling module, signals to the MT call handling module and the MO call handling module to indicate how to handle the MT call and the MO call.

### CROSS REFERENCE TO RELATED APPLICATIONS

This application claims priority of U.S. Provisional Patent Application No. 61/988,396, filed on May 5, 2014, the entirety of which is incorporated by reference herein.

### TECHNICAL FIELD

Aspects of the present invention relate generally to wireless communications systems, and more particularly, to methods and apparatuses for automatically setting up connection in case a call conflict occurs between two terminals.

### BACKGROUND

Wireless communications systems are widely deployed to provide various types of communication such as voice, packet data, and so on. These systems may be based on code division multiple access (CDMA), time division multiple access (TDMA), frequency division multiple access (FDMA), or other multiple access techniques. For example, such systems can conform to standards such as Third-Generation Partnership Project 2 (3GPP2, or “CDMA2000”), Third-Generation Partnership (3GPP, or “Wideband Code Division Multiple Access (W-CDMA)”), or Long Term Evolution (“LTE”).

FIG. 1A shows a schematic diagram illustrating an access domain selection (ADS) module of a user equipment (UE) for deciding the access domain of a mobile originated (MO) call. When the UE receives an MO call request from the upper layer, the ADS module decides to establish the MO call on the CS or IMS domain. When the CS domain is selected for the MO call, the UE then signals the network to establish the call on the CS domain. In some situations, the UE may have to perform a CS fallback procedure before starting the signaling. When the IMS domain is selected for the MO call, the UE then signals the network to establish the call on the IMS domain.

FIG. 1B shows a schematic diagram illustrating an access domain selection (ADS) function of a network for deciding the access domain of a mobile terminated (MT) call. When the network receives an MT call request from the caller's network, the ADS function of the network decides to establish the MT call on the CS or IMS domain. When the CS domain is selected for the MT call, the network then signals the UE to establish the call on the CS domain. In some situations, the network may have to trigger a CS fallback procedure before starting the signaling. When the IMS domain is selected for the MT call, the network then signals the UE to establish the call on the IMS domain.

Since the ADS functions for the MO calls and MT calls are performed by the UE and the network respectively, there is a chance that the resulting access domains of an MO call and an MT call are different.

In other words, there are two call conflict scenarios. In the first scenario as shown in FIG. 2A, the UE receives an MT call request on the CS domain while it is establishing an MO call on the IMS domain. In the second scenario as shown in FIG. 2B, the UE receives an MT call request on the CS domain while it is establishing an MO call on the IMS domain. For UEs which may be capable or incapable of maintaining a CS call and an IMS call at the same time, it is desired to have first access domain techniques for handling such call conflicts in the wireless communications system.

### SUMMARY

A detailed description is given in the following embodiments with reference to the accompanying drawings.

Methods and apparatuses for handling a call conflict are provided.

In one exemplary embodiment, the invention is directed to an apparatus for handling call conflicts. The apparatus operates as a UE and comprises an MT call handling module, an MO call handling module, and a call conflict handling module. The MT call handling module is intended for processing MT call requests from a network where the MT call requests may come from different access domains. The MO call handling module is intended for performing MO call establishments requested from the upper layer and the ADS function is integrated to the MO call handling module to decide the access domain for each MO call request. The call conflict handling module is intended for detecting and resolving the call conflict which occurs between the MT call handling module and the MO call handling module. More specifically, the call conflict handling module detects the situation, an MO call is being established by the MO call handling module on a certain access domain while at the same time an MT call request on another access domain is being processed by the MT call handling module. When a call conflict is detected, the call conflict handling module decides the resolution and signals the MT call handling module and the MO call handling module to react accordingly.

A detailed description is given in the following embodiments with reference to the accompanying drawings.

### BRIEF DESCRIPTION OF DRAWINGS

The present invention can be more fully understood by reading the subsequent detailed description and examples with references made to the accompanying drawings, wherein:

FIG. 1A shows a schematic diagram illustrating an ADS module of a UE for deciding the access domain of a MO call.

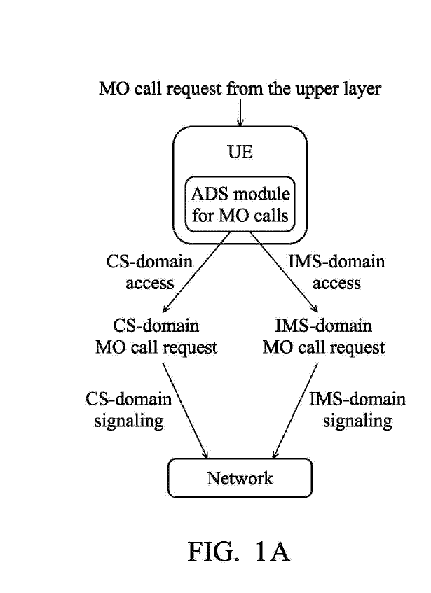

FIG. 1B shows a schematic diagram illustrating an ADS module of a network for deciding the access domain of a MT call.

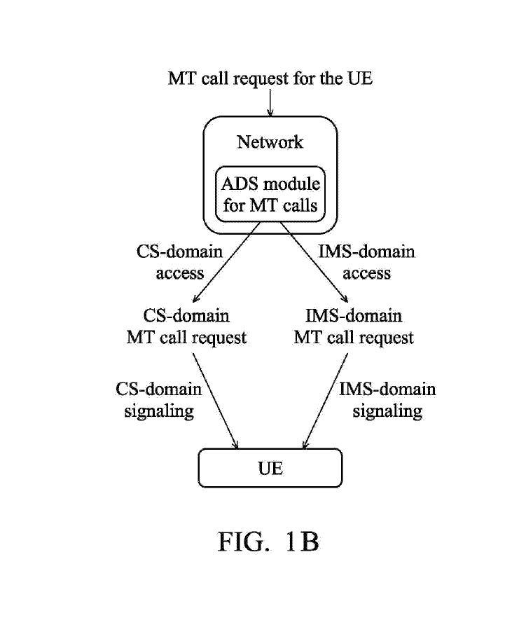

FIG. 2A shows a schematic diagram illustrating a conflict scenario that occurs when the UE receives an MT call request on the CS domain from the network but at the same moment an MO call is being established on the IMS domain.

FIG. 2B shows a schematic diagram illustrating a conflict scenario that occurs when the UE receives an MT call request on the IMS domain from the network but at the same moment an MO call is being established on the CS domain.

FIG. 3 is a schematic diagram for handling a call conflict of a wireless communications system according to one embodiment of the present invention;

FIG. 4 is a schematic diagram for handling a call conflict of a wireless communications system according to another embodiment of the present invention;

FIG. 5 is a schematic diagram for handling a call conflict of a wireless communications system according to another embodiment of the present invention; and

FIG. 6 is a flow diagram illustrating a method 600 for handling a call conflict according to the embodiment of the present invention with reference to FIG. 5.

### DETAILED DESCRIPTION

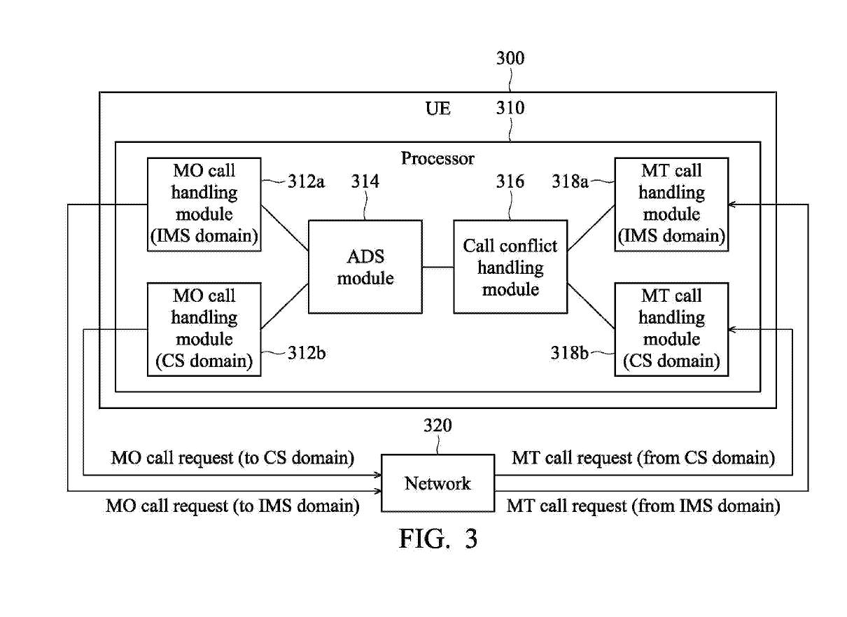

Several exemplary embodiments of the present disclosure are described with reference to FIGS. 3 through 6, which generally relate to a method and an apparatus handling a call conflict. It is to be understood that the following disclosure provides various embodiments as examples for implementing different features of the present disclosure. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

FIG. 3 is a schematic diagram for handling a call conflict of a wireless communications system according to one embodiment of the present invention. The wireless communications system includes a user equipment (UE) 300 and a network 320. The UE 300 may also be called an access terminal (AT), a wireless communications device, terminal, or some other terminology. The UE 300 includes at least a transmitter (not shown), and a receiver (not shown) and a processor 310, wherein the transmitter and the receiver are coupled to the processor 310. The processor 310 at least includes a mobile originated (MO) call handling module 312a used for the IMS domain, an MO call handling module 312b used for the CS domain, an access domain selection (ADS) module 314, a call conflict handling module 316, a mobile terminated (MT) call handling module 318a used for the IMS domain and an MT call handling module 318b used for the CS domain. In FIG. 3, the call conflict handling module 316 has a connection with the ADS module 314, the MT call handling module 318a, and the MT call handling module 318b of the UE 300.

The call conflict handling module 316 checks whether a call conflict is present between the MT call handling module 318b and the MO call handling module 312a, i.e., whether a CS-domain MT call request and an IMS-domain MO call request are present at the MT call handling module 318b and the MO call handling module 312a, respectively. When a call conflict is detected, the call conflict handling module 316 then decides the conflict resolution, i.e., how to handle the MO call and the MT call, and informs the MT call handling module 318b and the MO call handling module 312a to react accordingly.

The call conflict handling module 316 also checks whether a call conflict is present between the MT call handling module 318a and the MO call handling module 312b, i.e., whether an IMS-domain MT call request and an CS-domain MO call request are present at the MT call handling module 318a and the MO call handling module 312b, respectively. When a call conflict is detected, the call conflict handling module 316 then decides the conflict resolution, i.e., how to handle the MO call and the MT call, and informs the MT call handling module 318a and the MO call handling module 312b to react accordingly.

Therefore, there are two conflict scenarios that are addressed in accordance with the invention. The conflict scenarios are presented in Table 1 below.

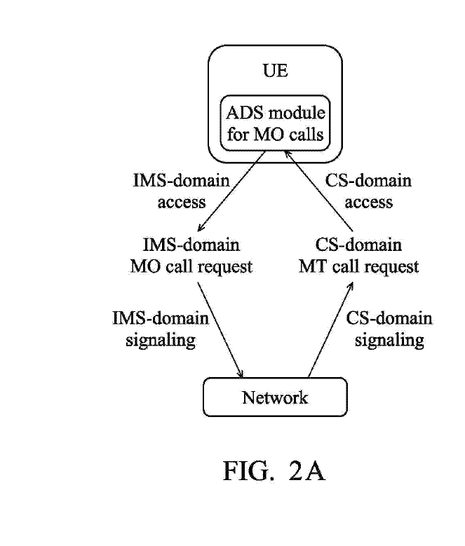

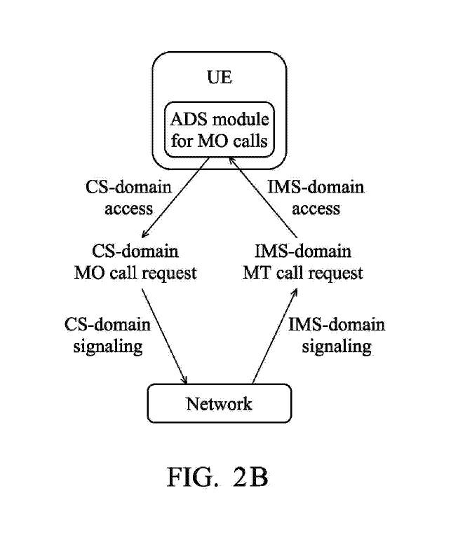

TABLE 1

| | Access domain of the | Access domain of the |
|---|---|---|
| | MO call | MT call |
| Conflict scenario 1 | IMS domain | CS domain |
| (as shown in FIG. 2A) | | |
| Conflict scenario 2 | CS domain | IMS domain |
| (as shown in FIG. 2B) | | |

For conflict scenario 1, the conflict resolution which may be taken by the call conflict handling module 316 is shown in Table 2.

TABLE 2

| | MO call handling module | MT call handling module |
|---|---|---|
| Resolution | (Current access domain: IMS) | (Current access domain: CS) |
| 1 | Continue the establishment of | Continue the establishment of |
| | the MO call on the IMS | the MT call on the CS domain |
| | domain | |
| 2 | Continue the establishment of | Continue the establishment of |
| | the MO call on the CS | the MT call on the CS domain |
| | domain | |
| 3 | Abort the establishment of the | Continue the establishment of |
| | MO call | the MT call on the CS domain |
| 4 | Continue the establishment of | Abort the establishment of the |
| | the MO call on the IMS | MT call |
| | domain | |
| 5 | Continue the establishment of | Abort the establishment of the |
| | the MO call on the CS | MT call |
| | domain | |
| 6 | Abort the establishment of the | Abort the establishment of the |
| | MO call | MT call |

When the call conflict handling module 316 decides to take resolution 1 in Table 2 for conflict scenario 1, it instructs the MT call handling module 318b to continue the establishment of the MT call on the CS domain, and instructs the MO call handling module 312a to continue the establishment of the MO call on the IMS domain. This resolution is in general applicable to UEs which have the ability of maintaining calls on different access domains at the same time. When the call conflict handling module 316 decides to take resolution 2 in Table 2 for conflict scenario 1, it instructs the MO call handling module 312a to abort the establishment of the MO call on the IMS domain, instructs the MO call handling module 312b to continue the establishment of the MO call on the CS domain, and instructs the MT call handling module 318b to continue the establishment of the MT call on the CS domain. In other words, the UE changes the access domain of the MO call from the IMS domain to the CS domain and continues the MO call establishment on the CS domain. When the call conflict handling module 316 decides to take resolution 3 in Table 2 for conflict scenario 1, it instructs the MO call handling module 312a to abort the establishment of the MO call, and instructs the MT call handling module 318b to continue the establishment of the MT call on the CS domain. When the call conflict handling module 316 decides to take resolution 4 in Table 2 for conflict scenario 1, it instructs the MO call handling module 312a to continue the establishment of the MO call on the IMS domain, and instructs the MT call handling module 318b to abort the establishment of the MT call. When the call conflict handling module 316 decides to take resolution 5 in Table 2 for conflict scenario 1, it instructs the MO call handling module 312a to abort the establishment of the MO call on the IMS domain, instructs the MO call handling module 312b to continue the establishment of the MO call on the CS domain, and instructs the MT call handling module 318b to abort the establishment of the MT call. In other words, the UE changes the access domain of the MO call from the IMS domain to the CS domain and continue the MO call establishment on the CS domain. When the call conflict handling module 316 decides to take resolution 6 in Table 2 for conflict scenario 1, it instructs the MO call handling module 312a to abort the establishment of the MO call, and instructs the MT call handling module 318b to abort the establishment of the MT call.

For conflict scenario 2, the conflict resolution which may be taken by the call conflict handling module 316 is shown in Table 3. The call conflict handling module 316 checks whether a call conflict is present between the MT call handling module 318a and the MO call handling module 312b, i.e., whether an IMS-domain MT call request and an CS-domain MO call request are present at the MT call handling module 318a and the MO call handling module 312b, respectively. When a call conflict is detected, the call conflict handling module 316 then decides the conflict resolution, i.e., how to handle the MO call and the MT call, and informs the MT call handling module 318a and the MO call handling module 312b to react accordingly.

TABLE 3

| | MO call handling module | MT call handling module |
|---|---|---|
| Case | (Current access domain: CS) | (Current access domain: IMS) |
| 1 | Continue the establishment of the | Continue the establishment of |
| | MO call on the CS domain | the MT call on the IMS |
| | | domain |
| 2 | Continue the establishment of the | Continue the establishment of |
| | MO call on the IMS domain | the MT call on the IMS |
| | | domain |
| 3 | Abort the establishment of the MO | Continue the establishment of |
| | call | the MT call on the INS |
| | | domain |
| 4 | Continue the establishment of the | Abort the establishment of the |
| | MO call on the CS domain | MT call |
| 5 | Continue the establishment of the | Abort the establishment of the |
| | MO call on the IMS domain | MT call |
| 6 | Abort the establishment of the MO | Abort the establishment of the |
| | call | MT call |

Since Table 3 is similar to Table 2, an elaboration of the details is skipped.

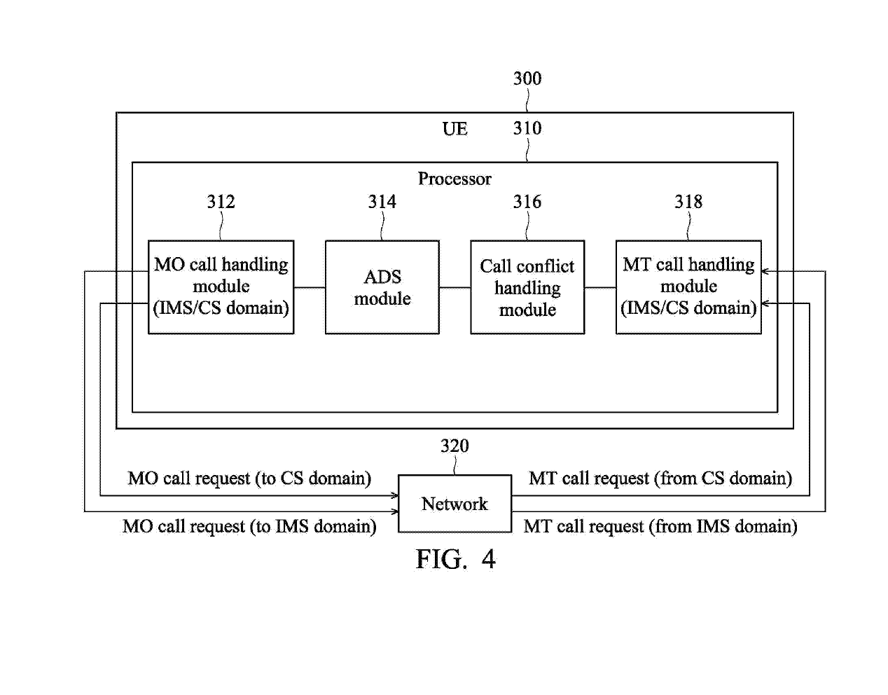

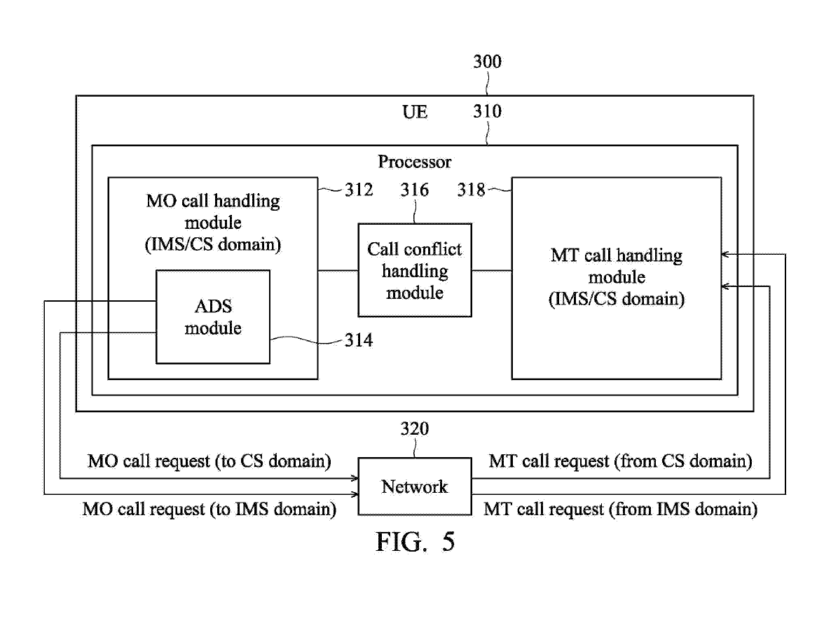

In one embodiment, the MO call handling module 312a and the MO call handling module 312b may be combined into a single MO call handling module (as the MO call handling module 312 in FIG. 4), and the MT call handling module 318a and the MO call handling module 318b may be combined into a single MT call handling module (as the MT call handling module 318 in FIG. 4). In another embodiment, the ADS module 314 may be further integrated into the MO call handling module (as the MO call handling module 312 in FIG. 5).

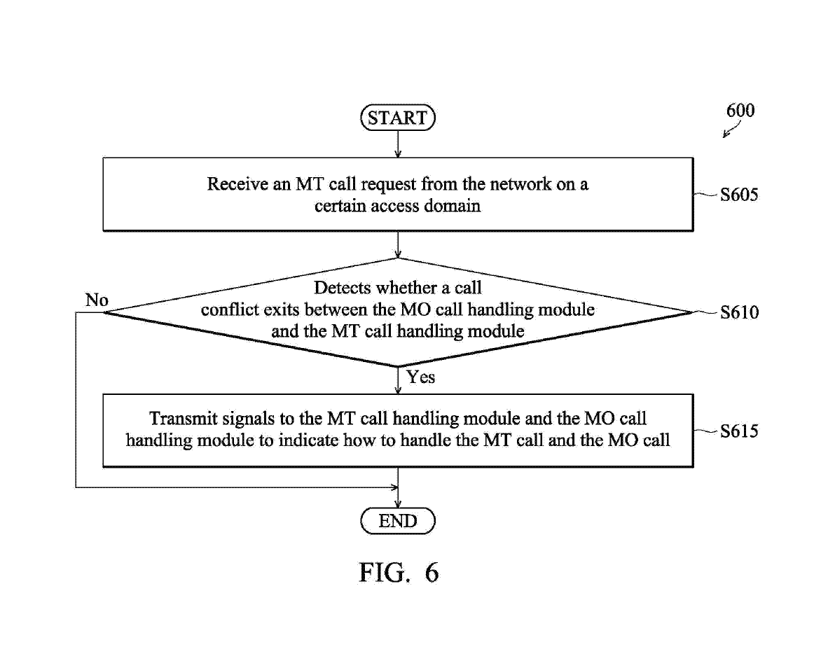

FIG. 6 is a flow diagram illustrating a method 600 for handling a call conflict according to the embodiment of the present invention with reference to FIG. 3. It is noted that the method is performed by a UE. First, in step S605, an MT call handling module of a UE receives an MT call request from the network on a certain access domain. Next, in step S610, a call conflict handling module of the UE detects whether a call conflict exits between the MO call handling module and the MT call handling module (by checking whether an MO call is being established on a different access domain than that of the MT call). When the call conflict is detected (“Yes” in step S610), in step S615, the call conflict handling module transmits signals to the MT call handling module and the MO call handling module to indicate how to handle the MT call and the MO call. Otherwise (“No” in step S610), the flow is finished.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using another structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those with skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those with skill in the art will further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in various ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for handling a call conflict for a user equipment (UE) in a communications network, comprising:
receiving, by a mobile terminated (MT) call handling module, an MT call request for establishing an MT call from a network on a first access domain;
detecting, by a call conflict handling module, whether a mobile originated (MO) call is being established at the same time by an MO call handling module on a second access domain; and
transmitting, by a call conflict handling module, signals to the MT call handling module and the MO call handling module to indicate how to handle the MT call and the MO call.

2. The method as claimed in claim 1, wherein the first access domain and the second access domain are different.

3. The method as claimed in claim 2, wherein the signals instruct the MT call handling module to continue establishment of the MT call on the first access domain, and instruct the MO call handling module to continue establishment of the MO call on the second access domain.

4. The method as claimed in claim 2, wherein the signals instruct the MO call handling module to change the access domain of the MO call to the first access domain and continue the MO call establishment on the first access domain, and instruct the MT call handling module to continue establishment of the MT call on the first access domain.

5. The method as claimed in claim 2, wherein the signals instruct the MO call handling module to abort establishment of the MO call, and instruct the MT call handling module to continue establishment of the MT call on the first access domain.

6. The method as claimed in claim 2, wherein the signals instruct that the MO call handling module to continue establishment of the MO call on the second access domain, and instruct the MT call handling module to abort establishment of the MT call.

7. The method as claimed in claim 2, wherein the signals instruct that the MO call handling module to change the access domain of the MO call to the first access domain and continue the MO call establishment on the first access domain, and instruct the MT call handling module to abort establishment of the MT call.

8. The method as claimed in claim 2, wherein the signals instruct that the MO call handling module to abort establishment of the MO call, and instruct the MT call handling module to abort establishment of the MT call.

9. The method as claimed in claim 1, wherein the first access domain and the second access domain are the same.

10. The method as claimed in claim 9, wherein the signals instruct the MO call handling module to continue establishment of the MO call on the second access domain, and instruct the MT call handling module to continue establishment of the MT call on the first access domain.

11. An apparatus for handling a call conflict, operating as a user equipment (UE), at least comprising:
a mobile terminated (MT) call handling module, receiving an MT call request for establishing an MT call from a network on a first access domain; and
a call conflict handling module, coupled to the MT call handling module and a mobile originated (MO) call handling module and detects whether an MO call is being established at the same time by an MO call handling module on a second access domain, and transmits signals to the MT call handling module and the MO call handling module to indicate how to handle the MT call and the MO call.

12. The apparatus for handling a call conflict as claimed in claim 11, wherein the first access domain and the second access domain are different.

13. The apparatus for handling a call conflict as claimed in claim 12, wherein the signals instruct the MT call handling module to continue establishment of the MT call on the first access domain, and instruct the MO call handling module to continue establishment of the MO call on the second access domain.

14. The apparatus for handling a call conflict as claimed in claim 12, wherein the signals instruct the MO call handling module to change the access domain of the MO call to the first access domain and continue the MO call establishment on the first access domain, and instruct the MT call handling module to continue the establishment of the MT call on the first access domain.

15. The apparatus for handling a call conflict as claimed in claim 12, wherein the signals instruct the MO call handling module to abort establishment of the MO call, and instruct the MT call handling module to continue establishment of the MT call on the first access domain.

16. The apparatus for handling a call conflict as claimed in claim 12, wherein the signals instruct the MO call handling module to continue establishment of the MO call on the second access domain and instruct the MT call handling module to abort establishment of the MT call.

17. The apparatus for handling a call conflict as claimed in claim 12, wherein the signals instruct the MO call handling module to change the access domain of the MO call to the first access domain and continue the MO call establishment on the first access domain, and instruct the MT call handling module to abort establishment of the MT call.

18. The apparatus for handling a call conflict as claimed in claim 12, wherein the signals instruct the MO call handling module to abort establishment of the MO call, and instruct the MT call handling module to abort establishment of the MT call.

19. The apparatus for handling a call conflict as claimed in claim 11, wherein the first access domain and the second access domain are the same.

20. The apparatus for handling a call conflict as claimed in claim 19, wherein the signals instruct the MO call handling module to continue establishment of the MO call on the second access domain, and instruct the MT call handling module to continue establishment of the MT call on the first access domain.
